(19) United States
(12) Patent Application Publication
(10) Pub. No.: US 2008/0071897 A1
(43) Pub. Date: Mar. 20, 2008

(54) METHOD, SYSTEM, AND COMPUTER PROGRAM PRODUCT FOR FEDERATING THE STATE AND BEHAVIOR OF A MANAGEABLE RESOURCE

(75) Inventors: Sandip A. Amin, Austin, TX (US); JaiPaul K. Antony, Highland, NY (US); Albert A. DeLucca, Wantagh, NY (US); John B. Diamond, Poughkeepsie, NY (US); Georg Ochs, Moetzingen (DE); Revathi Subramanian, White Plains, NY (US); Michael D. Williams, Gardiner, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/532,337

(22) Filed: Sep. 15, 2006

(51) Int. Cl. G06F 15/16; G06F 15/173

(52) U.S. Cl. 709/223; 709/203

(57) ABSTRACT

A method for federating the state and behavior of a manageable resource including: retrieving binding information for the manageable resource from a language processor; retrieving a correct proxy instance class name for the manageable resource using the binding information; and creating a proxy instance for a correct provider using the proxy instance class name.

### BACKGROUND OF THE INVENTION

This disclosure relates generally to resource management using Web services, and in particular, to a method, system, and storage medium for federating the state and behavior of a manageable resource using web services.

Management Using Web Services (MUWS) enables management of distributed information technology (IT) resources using Web services. Many distributed IT resources use different management interfaces; by leveraging Web service technology, MUWS enables easier and more efficient management of IT resources. This is accomplished by providing a flexible, common framework for manageability interfaces that leverage key features of Web services technologies. Universal management and interoperability across the many and various types of distributed IT resources can be achieved using MUWS. The types of management capabilities exposed by MUWS are the management capabilities generally expected in systems that manage distributed IT resources. Examples of manageability functions that can be performed via MUWS include monitoring the quality of a service, enforcing a service level agreement, controlling a task, and managing a resource lifecycle. Whenever possible, MUWS leverages existing Web services specifications to ensure interoperability, adoptability, and extensibility.

As used herein the term “manageable resource” refers to a resource capable of supporting one or more standard management capabilities. A manageable resource may be the representation of some physical IT resource (e.g., a computer system, network device, storage device, etc.). A particular management capability could be comprised of some set of state information, exposed as Web Service Resource Framework (WSRF) resource properties, and some operational behavior that a particular manageable resource exposes to a manageability consumer. Multiple agents and/or management systems may realize the state information and operational behavior of a manageable resource.

What is needed are methods to compose the state of a manageable resource, or a Web services resource (a.k.a. WS-Resource), from multiple agents and/or management systems, to dispatch operations to the correct agent and/or management systems, and to describe how state and operations are bound to a specific provider (agent, management system, and the like).

### BRIEF SUMMARY OF THE INVENTION

Exemplary embodiments include a method for federating the state and behavior of a manageable resource including: retrieving binding information for the manageable resource from a language processor; retrieving a correct proxy instance class name for the manageable resource using the binding information; and creating a proxy instance for a correct provider using the proxy instance class name.

Other exemplary embodiments include a computer program product for composing the state of a manageable resource across multiple management systems, the computer program product including: a storage medium readable by a processing circuit and storing instructions for execution by the processing circuit for facilitating a method comprising: retrieving binding information for the manageable resource from a language processor; retrieving a correct proxy instance class name for the manageable resource using the binding information; and creating a proxy instance for a correct provider using the proxy instance class name.

Further exemplary embodiments include a system for federating the state of a manageable resource across multiple management systems a resource federator operable for receiving binding information; a proxy in operable communication with the resource federator and the manageable resource, the proxy operable for receiving a state access, a mutation request, or an operation invocation from the resource federator; and a management system in operable communication with the proxy for receiving commands from a user.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

Referring now to the drawings wherein like elements are numbered alike in the several FIGURES:

FIG. 1 illustrates a block diagram of a federation engine in accordance with exemplary embodiments;

FIG. 2 illustrates a class diagram of a federation engine in accordance with exemplary embodiments;

FIG. 3 illustrates an interaction diagram for a get resource property request including components of the federation engine in accordance with exemplary embodiments;

FIG. 4 illustrates an interaction diagram for building a Resource Property Document including components of the federation engine in accordance with exemplary embodiments; and

FIG. 5 illustrates an interaction diagram for pushing an operation down to a specific management system including components of the federation engine in accordance with exemplary embodiments.

### DETAILED DESCRIPTION

The present invention and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the present invention in detail. The examples used herein are intended merely to facilitate an understanding of ways in which the invention may be practiced and to further enable those of skill in the art to practice the invention. Accordingly, the examples should not be construed as limiting the scope of the invention.

As discussed above, a manageable resource is a specialization of a Web services resource. As defined in the WSRF Resource Properties specification, the state of a Web services resource is exposed through the definition of a resource property document. The resource property document may be defined by an XML schema, and is intended to provide an external view of all of the state information that makes up a particular aspect of a physical IT resource. The properties that are exposed in the resource property document may not necessarily be provided by a single source, i.e. agent, management system, and the like. Some properties may be taken from a management system, such as an object manager (e.g., a CIM Object Manager), and others may be taken from another management system or some other agent/provider. In order to accurately reflect the state of a manageable resource, in support of some management capability, a federated view across these potentially disparate sources is provided.

For example, in one embodiment the manageable resource may be a printer. In this case, an implementer may choose to expose properties associated with the physical printer, such as a descriptive name for the printer being managed, the manufacturer of the printer, and the number of pending jobs for the printer. According to the MUWS specification, all manageable resources must expose an identifying property, which is a resource ID. It is also desired that the printer be able to accept print requests through a print operation. For example, the number of pending print jobs may need to be queried on the physical IT resource, by some system that knows how to access the printer, in order to get the current count, but another property, such as the name alias, may come from some static data source such as Entity Enterprise JavaBeans (EJB), Relational Database, or a flat file on the file system.

In exemplary embodiments, the manageable resource may expose a set of operations that cannot all be handled by any single agent/management system. In order to support all the operations outlined by some manageability capability it may be necessary to provide a means for dispatching these operations to the correct management system that knows how to perform the desired operation on the physical IT resource. For example, the print operation exposed by the manageable resource may be pushed down to some management system in order to submit the job for printing on the physical IT resource.

As used herein, the term “federation” refers to the binding of the state and operations of a manageable resource to one or more providers (agents, management systems, etc). In order to describe the policy for binding state and operations to a provider, it is necessary to define a language for the federation engine to use. The language provides a mapping between a property and/or operation name to some provider. The language may also define any information that is necessary to facilitate a connection to the specified provider. In the case where this provider is an EJB, the Java Naming and Directory Interface (JNDI) name may be required to lookup the entity; in other cases this information may need to include an IP address, port information, or the like. Optionally, the language may provide any quality of service features such as reliability, performance, and serviceability.

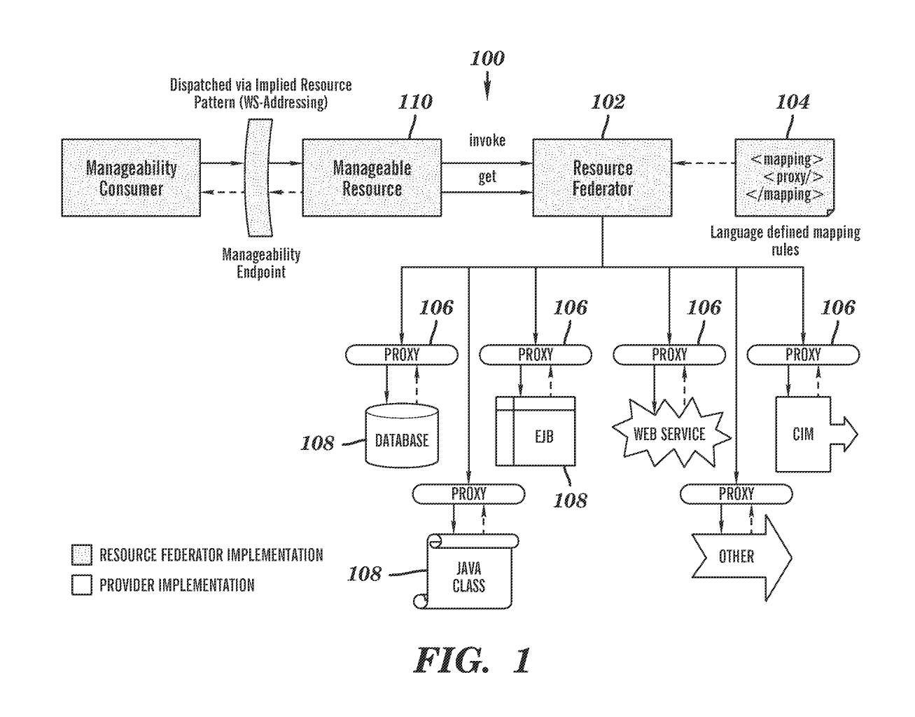

Referring now to FIG. 1, a block diagram of a federation engine in accordance with exemplary embodiments is referred to generally as 100. In exemplary embodiments, a resource federator 102 takes in an instance of the above-mentioned language 104, which is used as a source of binding information. The binding information is used to dispatch the state access, mutation request, or operation invocation to a correct proxy 106. The proxy 106 is an interface that provides a contract between resource federator 102 and a management system or agent 108, etc. The federation engine 100 is designed to allow support for new providers as the type and scope of manageable resources 110 grow.

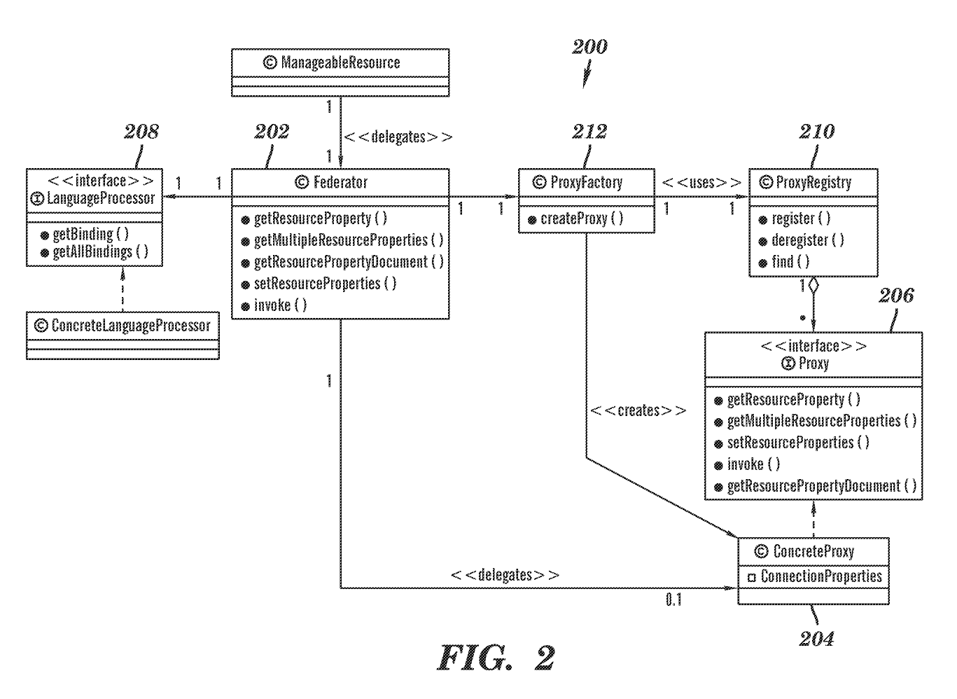

Turning now to FIG. 2, a class diagram of a federation engine in accordance with exemplary embodiments is referred to generally as 200. The main interaction point with the federation engine 200 is through the federator class 202. The federator class 202 coordinates the selection and creation of the correct proxy implementation class 204, as well as the dispatching of the desired method invocation to that proxy instance 206. In order to do this, a language processor instance 208 is necessary that knows how to parse the federation language that has been used in the supplied instance document. The main role of the language processor instance 208 is to obtain the correct binding information from the supplied language document that is necessary to facilitate the rest of the interaction.

A proxy registry 210 can be used to provide an extension point into the federation engine. The proxy registry 210 will store a mapping from the identifier used in the instance of the federation language provided to a concrete implementation of the proxy interface 206. This allows for the implementation of the proxy interface 206 to change without having to change the identifier in all instance documents. Also, the proxy registry 210 would allow for the dynamic registration and deregistration of proxy instances 206 and makes the federation engine 200 configurable at runtime. A proxy factory 212 is used to create instances of the correct concrete proxy implementation class 204 based on the mapping that is stored in the proxy registry 210.

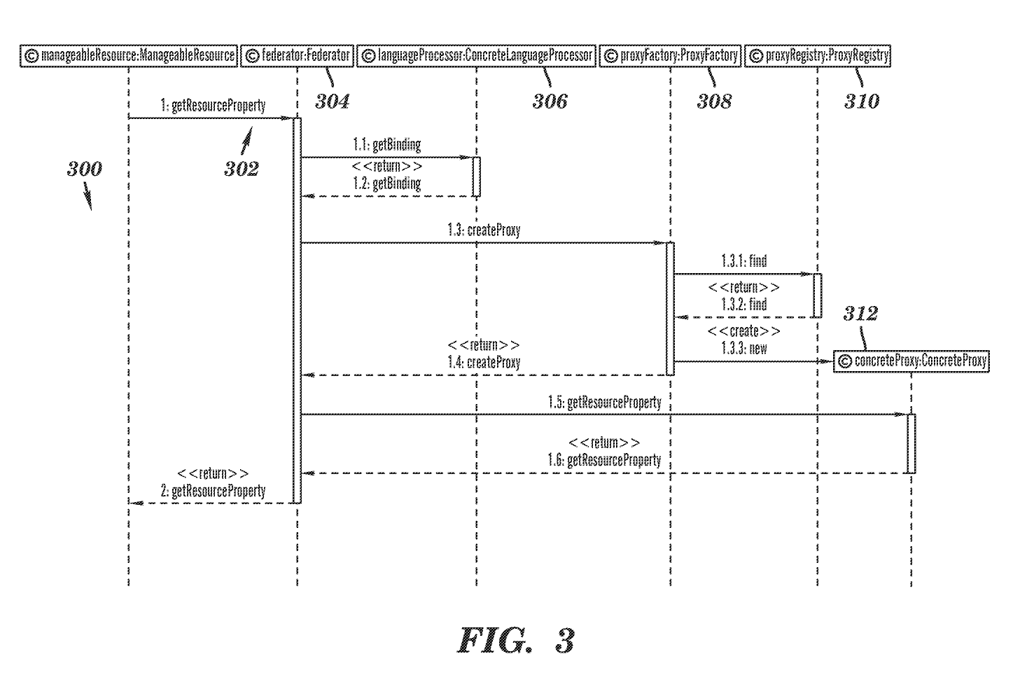

Turning now to FIG. 3, an interaction diagram for a get resource property request 302 including components of the federation engine in accordance with exemplary embodiments is referred to generally as 300. The get resource property request 302 utilizes a federation component 304 to retrieve a piece of state information from a provider. When the get resource property request 302 is received by the federator component 304, it uses an instance of a language processor 306 to obtain the correct binding information for the requested property name. The federator component 304 uses this binding information to ask a proxy factory 308 for an instance of the correct concrete proxy implementation. The proxy factory 308 in turn uses a proxy registry 310 to look up the correct proxy instance class name. The proxy instance class name is used to create a correct instance of the proxy interface 312. Once a proxy instance is obtained the request is forwarded to the proxy to be serviced by the correct provider.

In exemplary embodiments, all operations that are destined for a proxy instance may follow the same general pattern. In the case of a get multiple resource properties invocation, some optimizations may occur. Mainly, all properties that are destined for a single proxy instance, can be collected, and dispatched as a get multiple resource properties invocation, as opposed to a series of get multiple resource properties invocations on the same proxy instance. The get multiple resource properties may be optimized by a provider, and offer some benefit over single get multiple resource properties requests.

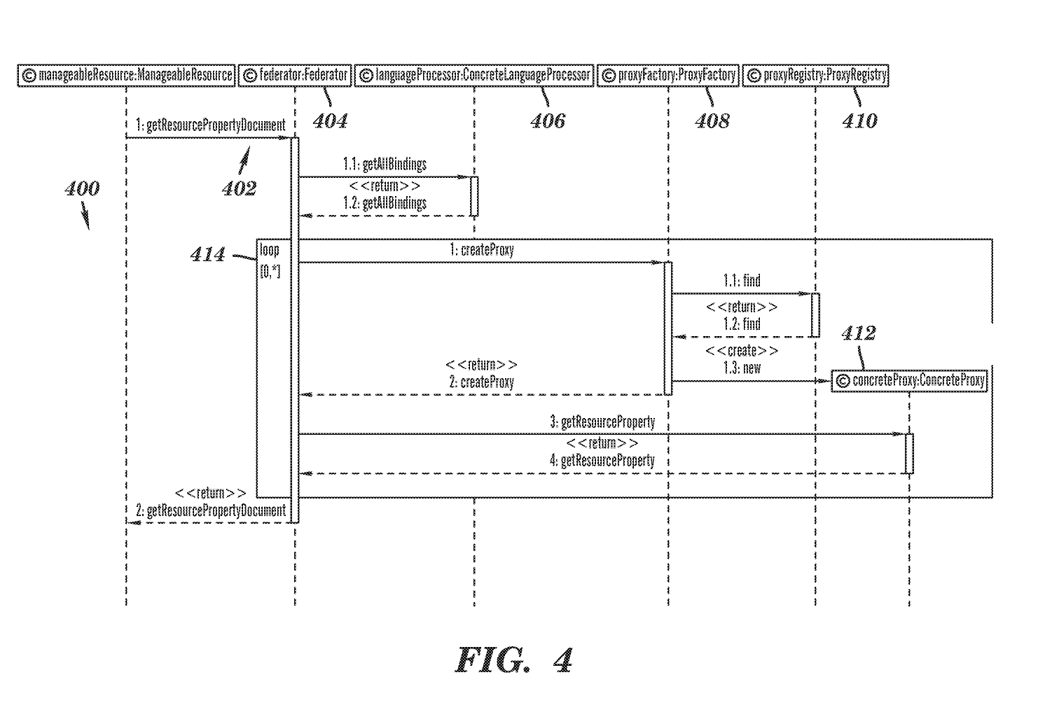

Turning now to FIG. 4, an interaction diagram for building a get resource property request 402 including components of the federation engine in accordance with exemplary embodiments is referred to generally as 400. FIG. 4 shows how a federator 404 can be used to build up a resource property document that contains elements from multiple providers. The federator 404 uses a language processor 406 to obtain the correct binding information for the requested property name. The federator component 404 uses this binding information to ask a proxy factory 408 for an instance of the correct concrete proxy implementation. The proxy factory 408 in turn uses a proxy registry 410 to look up the correct proxy instance class name. The proxy instance class name is used to create a correct instance of the proxy interface 412. As shown at loop 414, the federator component 404 iterates this process until a complete resource property document is created and returned. In an alternative exemplary embodiment, a manageable resource implementation may choose to replace the get resource property document 402 call to the federator 404 with multiple get resource property or get multiple resource properties invocations and build up the resource property document in their implementation. This may be the desired solution where the resource property document of the implementing service contains many complex data structures.

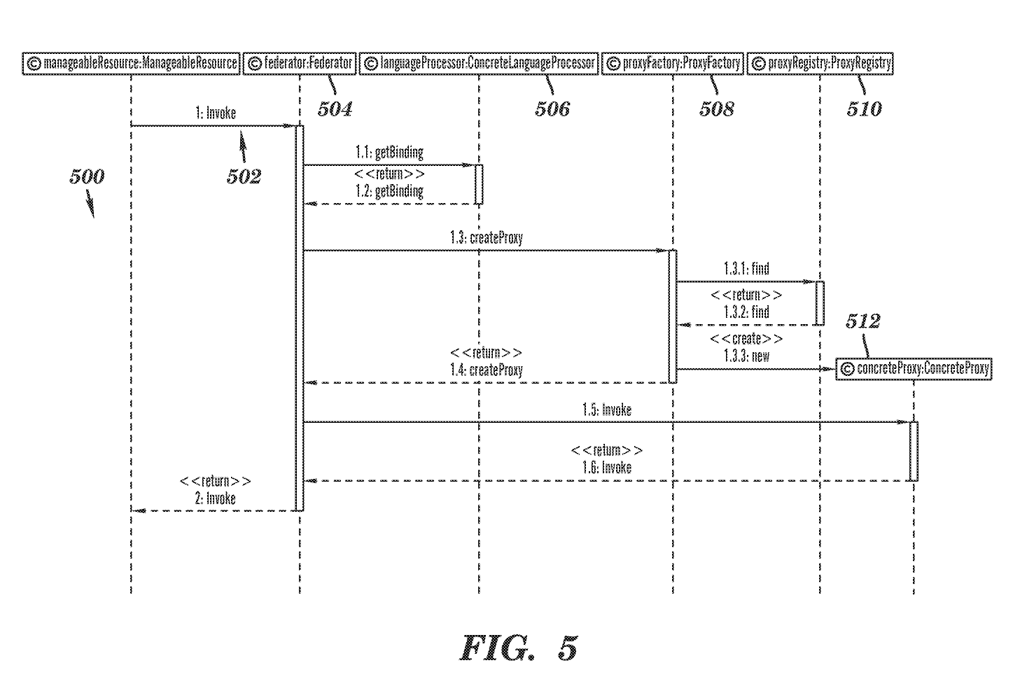

Referring now to FIG. 5, an interaction diagram that shows what occurs when an operation is pushed down to a specific management system, agent, or some other provider is generally depicted as 500. The operation request 502 utilizes a federator 504 to push the operation to the provider. The federator 504 uses an instance of a language processor 506 to obtain the correct binding information for the requested property name. The federator component 504 uses this binding information to ask a proxy factory 508 for an instance of the correct concrete proxy implementation. The proxy factory 508 in turn uses a proxy registry 510 to lookup the correct proxy instance class name. The proxy instance class name is used to create a correct instance of the proxy interface 512. The desired operation on the provider may be identified by some abstract identifier, which is used as a parameter to a generic invoke method. In turn, the parameter is used by a proxy instance to determine which method should be invoked on the underlying provider. This design allows for the service implementing this design to expose an operation on its interface that may potentially have a different signature from that of the signature on the provider. The invoke operation additionally takes in all of the parameters that are to be passed to the underlying operation on the provider.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for federating a state of a manageable resource across multiple management systems including:
retrieving binding information for the manageable resource from a language processor;
retrieving a correct proxy instance class name for the manageable resource using the binding information;
and creating a proxy instance for a correct provider using the proxy instance class name.

2. The method of claim 1, wherein the binding information comprises a state and an operation of the manageable resource.

3. The method of claim 1, wherein the manageable resource is a physical information technology (IT) resource.

4. The method of claim 1, wherein the manageable resource is a virtual information technology (IT) resource.

5. The method of claim 1, further comprising creating a resource property document corresponding to the manageable resource.

6. The method of claim 5, wherein the resource property document provides an external view of state information for the manageable resource.

7. The method of claim 1, wherein the binding information includes a set of operations that cannot all be handled by any single management system.

8. A computer program product for composing a state of a manageable resource across multiple management systems, the computer program product comprising:
a storage medium readable by a processing circuit and storing instructions for execution by the processing circuit for facilitating a method comprising:
retrieving binding information for the manageable resource from a language processor;
retrieving a correct proxy instance class name for the manageable resource using the binding information; and
creating a proxy instance for a correct provider using the proxy instance class name.

9. The computer program product of claim 8, wherein the binding information comprises a state and an operation of the manageable resource.

10. The computer program product of claim 8, wherein the manageable resource is a physical information technology (IT) resource.

11. The computer program product of claim 8, wherein the manageable resource is a virtual information technology (IT) resource.

12. The computer program product of claim 8, further comprising creating a resource property document corresponding to the manageable resource.

13. The computer program product of claim 12, wherein the resource property document provides an external view of a state information for the manageable resource.

14. The computer program product of claim 8, wherein the binding information includes a set of operations that cannot all be handled by any single management system.

15. A system for federating a state of a manageable resource across multiple management systems comprising:
a resource federator operable for receiving binding information;
a proxy in operable communication with the resource federator and the manageable resource, the proxy operable for receiving a state access, a mutation request, or an operation invocation from the resource federator; and
a management system in operable communication with the proxy for receiving commands from a user.
